(19) United States
(12) Patent Application Publication
(10) Pub. No.: US 2015/0262570 A1
(43) Pub. Date: Sep. 17, 2015

(54) APPARATUS DESCRIPTION PLAYER

(71) Applicant: Maad ABU-GHAZALAH, Gilroy, CA (US)

(72) Inventor: Maad ABU-GHAZALAH, Gilroy, CA (US)

(21) Appl. No.: 14/645,284

(22) Filed: Mar. 11, 2015

Related U.S. Application Data
(60) Provisional application No. 61/951,288, filed on Mar. 11, 2014.

(51) Int. Cl. G10L 13/00; G06F 17/30

(52) U.S. Cl. CPC G10L 13/00; G06F 17/30675; G06F 17/30696

(57) ABSTRACT

In an embodiment, a method includes receiving a first document via a computing device. The first document includes a description of an apparatus, a diagram including a component of the apparatus and a component reference number. The method also includes determining a name of the component via the computing device. In addition, the computing device displays the diagram. Moreover, during the display of the diagram, the computing device outputs audible speech of a portion of the description. The computing device utilizes the name to search for a second document related to the first document.

### CROSS-REFERENCE TO RELATED APPLICATION

This application claims the benefit of U.S. Provisional Patent Application No. 61/951,288, filed Mar. 11, 2014, entitled “Apparatus Description Player,” by Maad Abu-Ghazalah, Attorney Docket No. MAAD.P001.PRO, which is hereby incorporated by reference.

### BACKGROUND

Descriptions of an apparatus, such as those found in user's manuals and patent publications, often consist of a set of diagrams along with text describing the components in the diagrams. Each component on the diagram is numbered so that it can be referenced by the descriptive text. Conventionally, these descriptions can be reviewed by printing out the text and the diagrams, then reading each sentence one at a time, then referring to the diagram, finding the numbers referenced within that sentence, then returning to the text to read the next sentence. This process can be undesirable.

### SUMMARY

An embodiment in accordance with the invention can address the disadvantages described above by displaying a diagram of an apparatus description to a viewer while reading aloud and displaying a portion of the apparatus description while highlighting in the diagram corresponding component reference numbers and names as they are read out loud.

In an embodiment, a method includes receiving a first document via a computing device. The first document includes a description of an apparatus, a diagram including a component of the apparatus and a component reference number. The method also includes determining a name of the component via the computing device. In addition, the computing device displays the diagram. Moreover, during the display of the diagram, the computing device outputs audible speech of a portion of the description. The computing device utilizes the name to search for a second document related to the first document.

In another embodiment, a method including receiving a first document via a computing system. The first document includes a description of an apparatus and a component of the apparatus, a diagram including the component and a component reference number. The computing system determines a name of the component using the description. In addition, the computing system displays the diagram. During the display of the diagram, the computing system outputs audible speech of a sentence of the description. In addition, during the display of the diagram, the computing system displays a search interface. The computing system utilizes the name to search for a second document related to the first document.

In yet another embodiment, a method including a computing device receiving a first document. The first document includes a description of an apparatus and a plurality of components of the apparatus, a diagram including the plurality of components and a plurality of component reference numbers. The computing device determines a name of each of the plurality of components. The computing device displays the diagram. During the display of the diagram, the computing device outputs audible speech of a portion of the description. The computing device utilizes the plurality of names to search for a second document related to the first document.

While particular embodiments in accordance with the invention have been specifically described within this Summary, it is noted that the invention and the claimed subject matter are not limited in any way by these embodiments.

### BRIEF DESCRIPTION OF THE DRAWINGS

Within the accompanying drawings, various embodiments in accordance with the invention are illustrated by way of example and not by way of limitation. It is noted that like reference numerals denote similar elements throughout the drawings.

FIG. 1 is an apparatus description viewer system or device in accordance with various embodiments of the invention.

FIG. 2 illustrates further functionality of the apparatus description viewer system in accordance with various embodiments of the invention.

FIG. 3 illustrates more functionality of the apparatus description viewer system in accordance with various embodiments of the invention.

FIG. 4 illustrates still more functionality of the apparatus description viewer system in accordance with various embodiments of the invention.

FIG. 5 is a flow diagram in accordance with various embodiments of the invention.

FIG. 6 is another flow diagram in accordance with various embodiments of the invention.

FIG. 7 is yet another flow diagram in accordance with various embodiments of the invention.

FIG. 8 is a block diagram of a computing system in accordance with various embodiments of the invention.

The drawings referred to in this description should not be understood as being drawn to scale except if specifically noted.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the various embodiments of the invention may be practiced without these specific details or with equivalents thereof. In other instances, well known methods, procedures, components, and circuits have not been described in detail as not to unnecessarily obscure aspects of the invention.

Some portions of the detailed description are presented in terms of procedures, steps, logic blocks, processing, and other symbolic representations of operations on data bits that can be performed on computer or computing device memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system or computing device. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “receiving,” “determining,” “displaying,” “storing,” “transmitting,” “outputting,” “utilizing,” “identifying”, “highlighting” or the like, refer to the action and processes of a computer system or computing device that manipulates and transforms data represented as physical (electronic) quantities within its registers and/or memories into other data similarly represented as physical quantities within its memories, registers, and/or other such information storage, transmission or display devices.

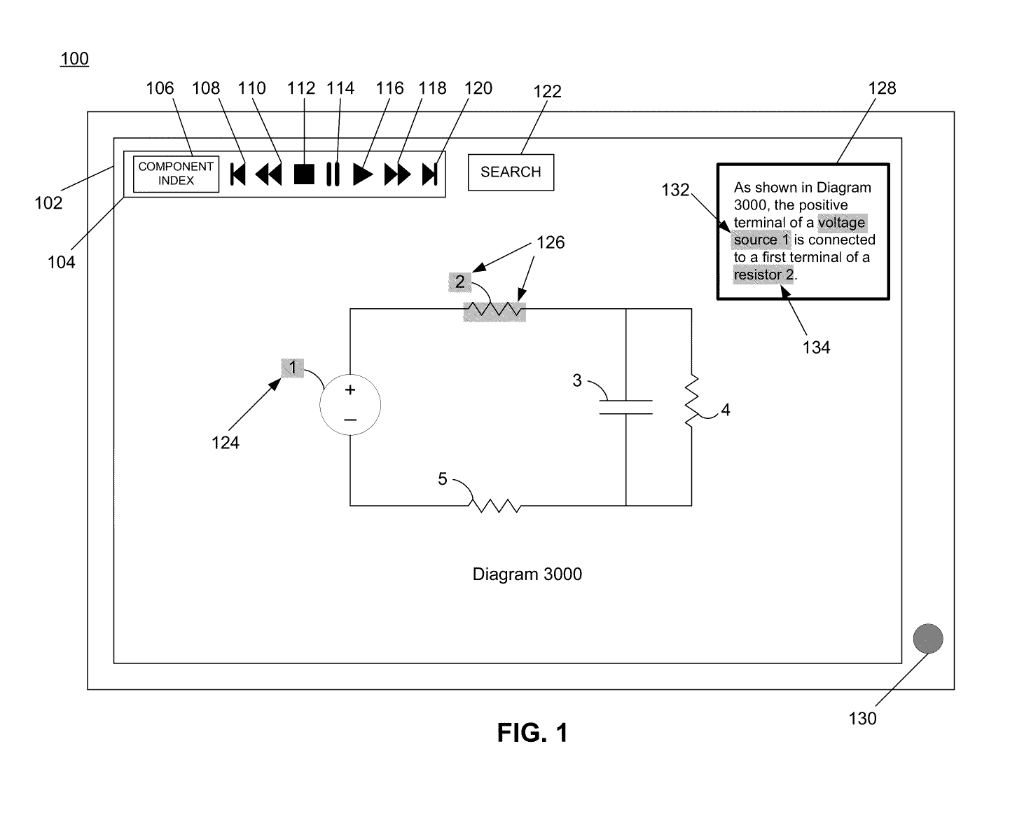

Various embodiments in accordance with the invention make it easier to review descriptions of an apparatus without having to look back and forth between the text and diagrams. For example, a user of an apparatus description viewer system (e.g., 100 of FIG. 1) in accordance with an embodiment can look at a diagram displayed by the system while each sentence is read aloud by the system via an audio speaker and the appropriate component numbers are highlighted in the displayed diagram by the system as they are referenced during the reading. Therefore, this functionality can be beneficial to the user if the apparatus description viewer system (e.g., 100 of FIG. 1) in accordance with an embodiment is implemented with a computing device having limited display area, such as, a smart phone, a tablet computer, a phablet, or a laptop computer.

FIG. 1 is an apparatus description viewer system or device 100 in accordance with various embodiments of the invention. In various embodiments, note that the apparatus description viewer system 100 can operate with a document that includes one or more diagrams having one or more component reference numbers together with text describing the components along with their corresponding reference numbers. For example, in an embodiment, the document can include, but is not limited to, a patent application, a patent, an assembly instructions document, a repair manual, and the like. It is noted that the apparatus description viewer system 100 can include a display device 102 for displaying video and/or graphic images and alphanumeric characters recognizable to a user. In addition, the apparatus description viewer system 100 can also include an audio speaker(s) 130 for outputting any type of audio signals or sounds produced by viewer system 100 that may, for example, be heard and/or recognizable to a user. In various embodiments, the apparatus description viewer system 100 can be implemented with a computing device such as, but is not limited to, a smart phone, a tablet computer, a phablet, a laptop computer, a desktop computer, a computer system, and the like.

Within FIG. 1, a screenshot in accordance with various embodiments of the invention is displayed by the display device 102 of the apparatus description viewer system 100. It is noted that in accordance with various embodiments, the apparatus description viewer system 100 can operate in a wide variety of ways. For example, in an embodiment, the apparatus description viewer system 100 can read aloud or audible via the speaker 130 an apparatus description of a diagram (e.g., 3000) while displaying via display 102 the corresponding diagram but not display any text that is being read aloud. In an embodiment, the apparatus description viewer system 100 can read aloud via the speaker 130 an apparatus description of a diagram while displaying via display 102 the diagram and not display any text that is being read aloud but the system 100 could highlight each component reference number within the displayed diagram as it is discussed. In an embodiment, the apparatus description viewer system 100 can read aloud via the speaker 130 an apparatus description of a diagram while displaying via display 102 the corresponding diagram and displaying a portion of the text being read while highlighting each corresponding component reference number within the displayed diagram as it is discussed. In an embodiment, the apparatus description viewer system 100 can read aloud via the speaker 130 an apparatus description of a diagram while displaying via display 102 the corresponding diagram and displaying a paragraph of the text being read while highlighting each corresponding component reference number within the displayed diagram as it is discussed.

Within the present embodiment, the viewer system 100 can display an exemplary apparatus diagram (e.g., 3000) via display device 102, along with component numbers referenced in an apparatus description (not shown). In an embodiment, the viewer system 100 can display within a text window 128 a portion of the apparatus description alongside the associated displayed apparatus diagram. While displaying the apparatus diagram and the text window 128, the viewer system 100 in an embodiment reads aloud via the speaker 130 the portion of the apparatus description displayed within the text window 128. In an embodiment, as the sentence is read aloud by system 100, the component numbers and/or names referenced in the displayed texted can be highlighted as shown by highlights 132 and 134 and in the diagram of the apparatus as well, as shown by highlights 124 and 126.

Within FIG. 1, in an embodiment, the viewer system 100 can display a navigation interface 104 via display device 102 to enable a viewer to move forward and backward through the audible description of the apparatus, and to re-watch already viewed portions. In an embodiment, the navigation interface 104 can include, but is not limited to, a component index or list “button” 106, a skip backward “button” 108, a rewind “button” 110, a stop “button” 112, a pause “button” 114, a play “button” 116, a fast forward “button” 118, and a skip forward “button” 120.

Specifically, in an embodiment, the component index or list “button” 106 can be selected for displaying a component index (e.g., 202) while the skip backward “button” 108 can be selected for skipping to a previous component description of the audio apparatus description. In an embodiment, the rewind “button” 110 can be selected for rewinding playback of the audio apparatus description, the stop “button” 112 can be selected for stopping playback of the audio apparatus description, the pause “button” 114 can be selected for pausing playback of the audio apparatus description, the play “button” 116 can be selected for initiating playback of the audio apparatus description, the fast forward “button” 118 can be selected for fast forwarding playback of the audio apparatus description, and the skip forward “button” 120 can be selected for skipping to a subsequent component description of the audio apparatus description. In various embodiments, the rewind “button” 110 can be selected for navigating to a previous sentence of the audio apparatus description, the skip forward “button” 120 can be selected for navigating to the last sentence of the audio apparatus description, the skip backward “button” 108 can be selected for navigating to the first sentence of the audio apparatus description, and the rewind “button” 110 can be selected for repeating the displayed sentence of the audio apparatus description. In various embodiments, the rewind button 110 and fast forward button 118 can be utilized to control the speed with which the description of the apparatus is presented, both audibly and visibly.

Within FIG. 1, in an embodiment of the present disclosure, when a viewer does not interact with the system 100 via the navigation interface 104, the description of the apparatus can be read aloud sentence-by-sentence, with corresponding visual indicators (e.g., highlighting) for the referenced component numbers. In an embodiment of the present disclosure, the system 100 automatically proceeds through the apparatus description. In one embodiment, a component itself (e.g., resistor 2) instead of or along with the component number can be highlighted in the diagram as the displayed sentence is read aloud.

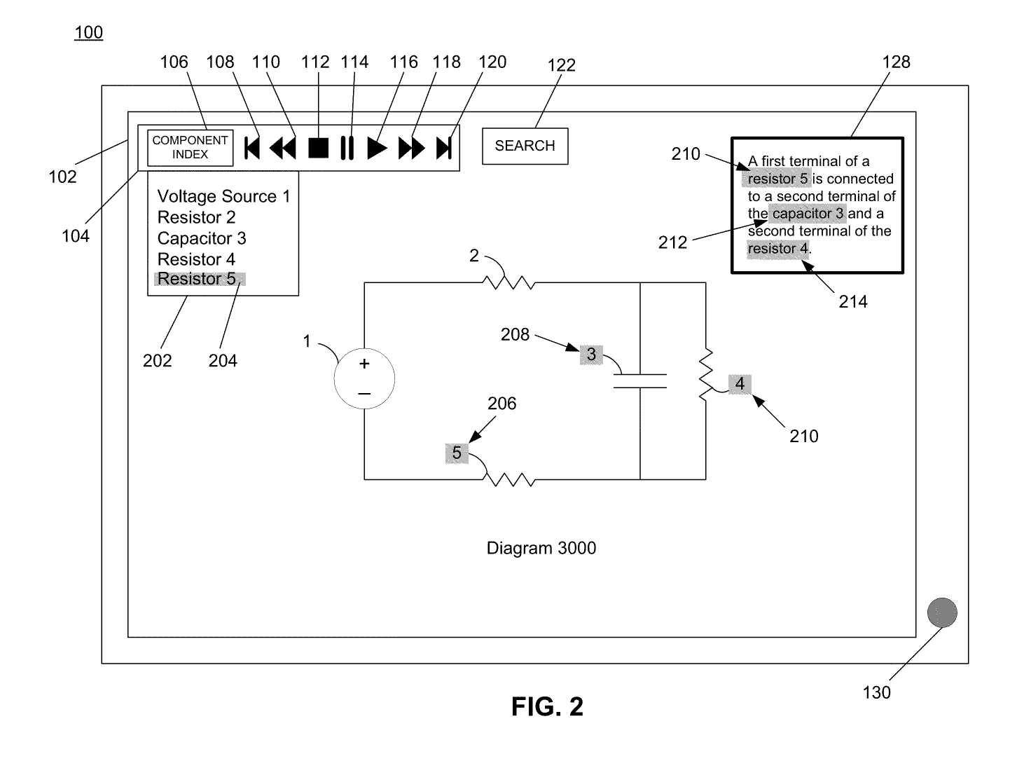

In an embodiment, the system 100 can identify all the components of the description of the apparatus. Once all the components in the description are identified, they are able to be categorized for further use by the system 100. For example, in an embodiment, the system 100 can generate a component index or list which can be utilized for different purposes. One purpose the component index can be used for is to enable the system 100 to display a dropdown of all component names with their component numbers. Specifically, in an embodiment, if the component index button 104 is selected within FIG. 2, the system 100 can display a dropdown 202 of all component names with their component numbers associated with the description of the apparatus. If a user selects a component name and number within dropdown 202, as shown by highlight 204, playback can start from the point at which the component name (e.g., resistor 5) is referenced in the text, as shown within text window 128. The system 100 can then read aloud the text within text window 128 of FIG. 2. As the sentence is read aloud by system 100, the component names and/or numbers referenced in the displayed texted can be highlighted as shown by highlights 210, 212, and 214 and in the diagram of the apparatus as well, as shown by highlights 206, 208, and 210.

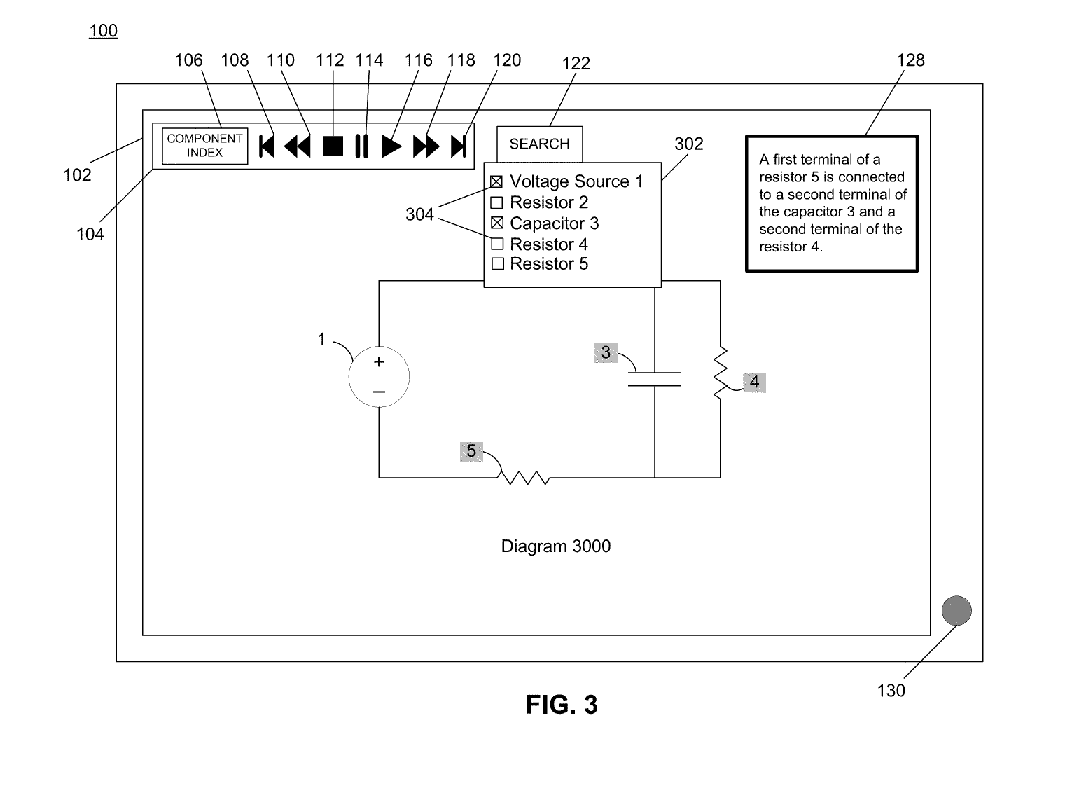

Another purpose the component index can be used for is to enable the system 100 to perform a search of one or more databases for related documents. In various embodiments, the related documents can include, but is not limited to, patent applications, patents, technical articles, and/or documents that include component reference numbers in their description and their one or more diagrams or figures. For example, in an embodiment, if the search “button” 122 is selected within FIG. 3, a dropdown 302 can be displayed by the system 100. Note that the dropdown 302 enables a user to select one or more components of the component index via selection boxes 304 to search for documents having similar components and/or subject-matter. Once one or more selection boxes 304 are selected, the search button 122 can be selected to begin the search by the system 100. The system 100 can conduct the search in the one or more databases (e.g., via parsing one or more databases) to look for common components within different documents.

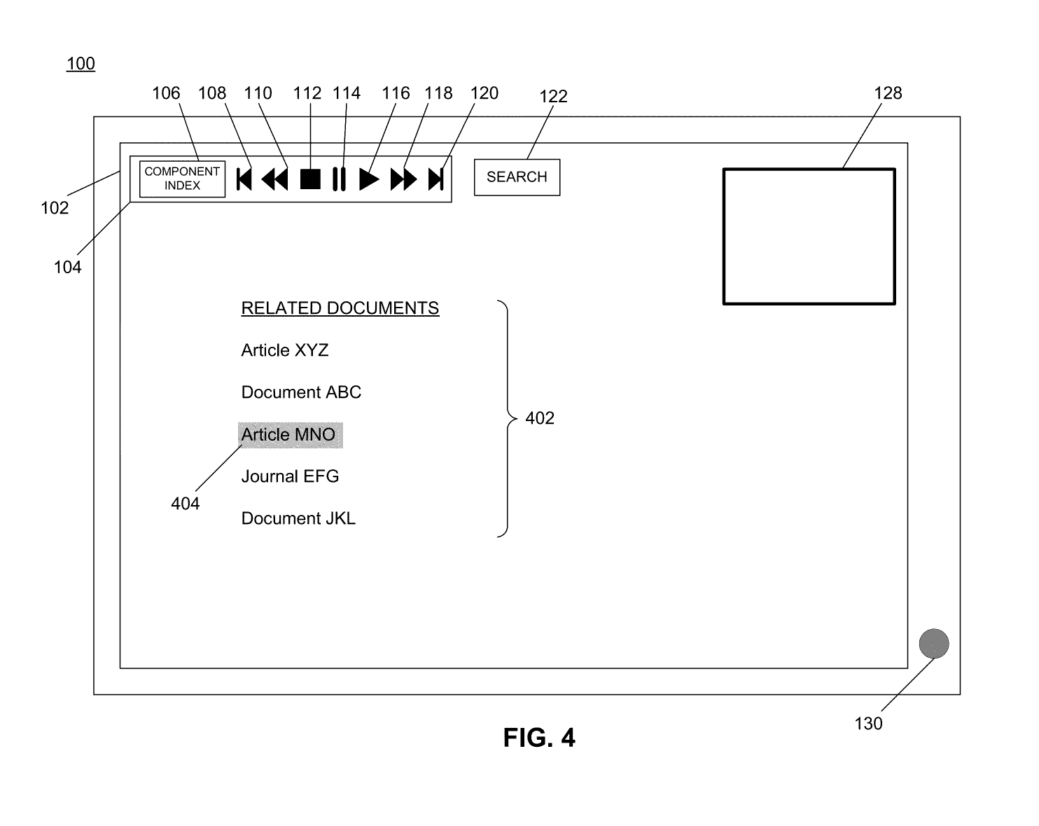

Within FIG. 4, after the search, the system 100 can generate and display a related documents list 402 that can include an identifying link for each found related document. For example, a user can select an identifying link for a related document, as represented by highlight 404, which can result in the system 100 displaying one or more diagrams of the document and performing a playback of the apparatus description, as described herein. It is pointed out that in an embodiment, one or more components from the description of a patent may be selected via dropdown 302 and used to search for patents having similar subject-matter, where the searching is conducted in a database (e.g., via parsing a database) to look for common components between patents. Various embodiments of the present disclosure may also be implemented using other documents having diagrams and accompanying descriptions.

With reference to FIGS. 3 and 4, in an embodiment, if the search button 122 within FIG. 3 is selected by a user, a dropdown 302 can be displayed by the system 100. The user can utilize the selection boxes 304 of the dropdown 302 to select one or more components from a list of components for a search of a database. The user can then select the search button 122 to begin the search by the system 100. After the search, the system 100 of FIG. 4 can generate and provide the user with a result set (e.g., 402) consisting of all the patents, patent applications, technical articles, and/or documents that contain those components prioritized by the number of matching components and/or the frequency in which those components are mentioned.

With reference to FIGS. 3 and 4, in an embodiment, note that the dropdown 302 can be implemented to include a “global” list of components (e.g., component names and reference numbers) determined by system 100 from an entire database of patents rather than just from one patent. In addition, in an embodiment, the dropdown 302 can be implemented to include a “global” list of components (e.g., component names and reference numbers) determined by system 100 from an entire database of patents, patent applications, technical articles, and/or documents rather than just from one patent, one patent application, one technical article, or one document. Next, in an embodiment, a user can utilize the selection boxes 304 of the dropdown 302 to select one or more components from the “global” list of components for a search of the database. The user can then select the search button 122 to begin the search by the system 100. As a result of the search, in an embodiment, the system 100 of FIG. 4 can generate and provide the user with a result set (e.g., 402) consisting of all the patents, patent applications, technical articles, and/or documents that contain those components prioritized by the number of matching components and/or the frequency in which those components are mentioned.

It is noted that the apparatus description viewer system 100 may not include all of the elements illustrated by FIGS. 1, 2, 3, and 4. In addition, the apparatus description viewer system 100 can be implemented to include one or more elements not illustrated by FIGS. 1, 2, 3, and 4. It is pointed out that the apparatus description viewer system 100 can be utilized or implemented in any manner similar to that described herein, but is not limited to such.

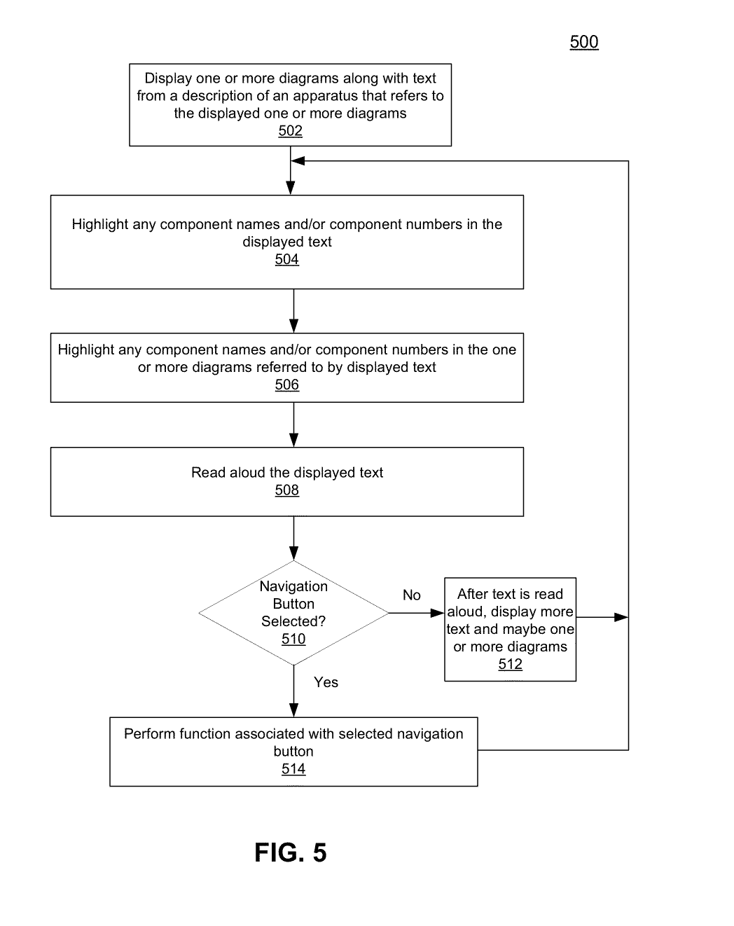

FIG. 5 is a flow diagram of a method 500 for an apparatus description viewer system or device (e.g., 100) to audibly and visibly present an apparatus description that includes one or more diagrams in accordance with various embodiments of the invention. Although specific operations are disclosed in FIG. 5, such operations are examples. The method 500 may not include all of the operations illustrated by FIG. 5. Also, method 500 may include various other operations and/or variations of the operations shown. Likewise, the sequence of the operations of flow diagram 500 can be modified. It is appreciated that not all of the operations in flow diagram 500 may be performed. In various embodiments, one or more of the operations of method 500 can be controlled or managed by software, by firmware, by hardware or by any combination thereof, but is not limited to such. Method 500 can include processes of embodiments of the invention which can be controlled or managed by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium or memory.

At operation 502 of FIG. 5, an apparatus description viewer system or device (e.g., 100) can display one or more diagrams along with text from a description (or document) of an apparatus that refers to the displayed one or more diagrams. It is noted that operation 502 can be implemented in a wide variety of ways. For example, in an embodiment, the description of the apparatus at operation 502 can include, but is not limited to, a description of at least one component and its component reference number included within the displayed one or more diagrams. In addition, in an embodiment, the text from the description that is displayed at operation 502 can include, but is not limited to, one or more sentences of text from the description, one or more paragraphs of text from the description, text including a first occurrence of a component reference number through a second occurrence of the component reference number from the description, any portion or amount of text from the description. Operation 502 can be implemented in any manner similar to that described herein, but is not limited to such.

At operation 504, the apparatus description viewer system can highlight (or generate one or more visual indicators to draw attention to) any component names and/or component numbers in the displayed text. Note that operation 504 can be implemented in a wide variety of ways. For example, in an embodiment, the apparatus description viewer system at operation 504 can, but is not limited to, circle, underline, and/or bold any component names and/or component numbers in the displayed text in order to draw attention to them. Operation 504 can be implemented in any manner similar to that described herein, but is not limited to such.

At operation 506 of FIG. 5, the apparatus description viewer system can highlight (or generate one or more visual indicators to draw attention to) any component names and/or component numbers in the one or more diagrams referred to by the displayed text. It is pointed out that operation 506 can be implemented in a wide variety of ways. For example, in various embodiments, the apparatus description viewer system at operation 506 can, but is not limited to, circle, underline and/or bold any component names and/or component numbers in the one or more diagrams referred to by the displayed text. Operation 506 can be implemented in any manner similar to that described herein, but is not limited to such.

At operation 508, the apparatus description viewer system can read aloud the displayed text via one or more audio speakers (e.g., 130). Note that operation 508 can be implemented in a wide variety of ways. For example, in an embodiment, the apparatus description viewer system at operation 508 can output audible speech corresponding to reading the displayed text via one or more audio speakers. In this manner, a user of the apparatus description viewer system can listen to the displayed text being read aloud while viewing the displayed one or more diagrams. Operation 508 can be implemented in any manner similar to that described herein, but is not limited to such.

At operation 510 of FIG. 5, a determination can be made as to whether any of the navigation buttons (e.g., 106, 108, 110, 112, 114, 116, 118, 120, and 122) have been selected while displayed by the apparatus description viewer system. If not, method 500 proceeds to operation 512. However, if it is determined at operation 510 that any of the navigation buttons have been selected while displayed by the apparatus description viewer system, method 500 proceeds to operation 514. Note that operation 510 can be implemented in a wide variety of ways. For example, operation 510 can be implemented in any manner similar to that described herein, but is not limited to such.

At operation 512, after the displayed text is read aloud by the apparatus description viewer system, the apparatus description viewer system can display additional text from the description of the apparatus. Note that if the additional text displayed at operation 512 no longer refers to any component in the displayed one or more diagrams, the apparatus description viewer system can display at operation 512 one or more diagrams that include one or more components referred to by the displayed additional text. It is pointed out that operation 512 can be implemented in a wide variety of ways. For example, operation 512 can be implemented in any manner similar to that described herein, but is not limited to such. After completion of operation 512, method 500 proceeds to the beginning of operation 504.

At operation 514 of FIG. 5, the apparatus description viewer system can perform the one or more functions associated with the one or more selected navigation buttons. Note that operation 514 can be implemented in a wide variety of ways. For example, at operation 514 the one or more functions associated with the one or more selected navigation buttons can include, but are not limited to, displaying a component index or list, skipping to a previous component description of the audio/visual apparatus description, rewinding playback of the audio/visual apparatus description, stopping playback of the audio/visual apparatus description, pausing playback of the audio/visual apparatus description, initiating playback of the audio/visual apparatus description, fast forwarding playback of the audio/visual apparatus description, skipping to a subsequent component description of the audio/visual apparatus description, navigate to a previous sentence of the audio/visual apparatus description, navigate to the last sentence of the audio/visual apparatus description, navigate to the first sentence of the audio/visual apparatus description, and repeat the displayed sentence of the audio/visual apparatus description. Operation 514 can be implemented in any manner similar to that described herein, but is not limited to such. Therefore, method 500 enables an apparatus description viewer system or device (e.g., 100) to audibly and visibly present an apparatus description that includes one or more diagrams in accordance with various embodiments of the invention.

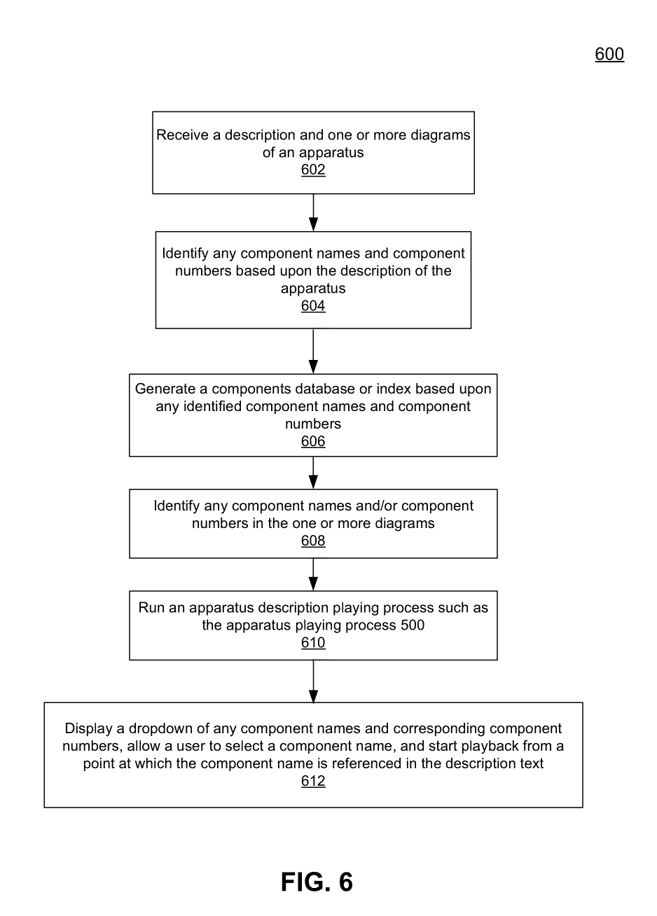

In various embodiments of the present disclosure, system 100 can generate the patent player automatically on virtually any patent, such that a large database of “player-enabled” patents can be generated automatically, as illustrated by exemplary process 600 in FIG. 6. In an embodiment, note that patent applications can be substituted for patents within the previous sentence. In addition, in an embodiment, it is noted that any documents that include a description and one or more diagrams with component reference numbers referred to in the description can be substituted for patents within the first sentence of this paragraph.

FIG. 6 is a flow diagram of a method 600 for automatically generating the functionality of an apparatus description viewer system or device (e.g., 100) in accordance with various embodiments of the invention. Although specific operations are disclosed in FIG. 6, such operations are examples. The method 600 may not include all of the operations illustrated by FIG. 6. Also, method 600 may include various other operations and/or variations of the operations shown. Likewise, the sequence of the operations of flow diagram 600 can be modified. It is appreciated that not all of the operations in flow diagram 600 may be performed. In various embodiments, one or more of the operations of method 600 can be controlled or managed by software, by firmware, by hardware or by any combination thereof, but is not limited to such. Method 600 can include processes of embodiments of the invention which can be controlled or managed by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium or memory.

At operation 602 of FIG. 6, an apparatus description viewer system or device (e.g., 100) can receive a description and one or more diagrams of an apparatus. It is noted that operation 602 can be implemented in a wide variety of ways. For example, in an embodiment, the description can be received at operation 602 by the apparatus description viewer system from one or more computing systems or devices via one or more communication networks (e.g., the Internet). In an embodiment, the description of an apparatus at operation 602 can include, but is not limited to, a description of one or more apparatuses. In an embodiment, the description of an apparatus at operation 602 can include, but is not limited to, a description of one or more components of the apparatus along with their reference numbers that can be shown within the one or more diagrams. In various embodiments, the description of an apparatus at operation 602 can include, but is not limited to, a patent application, a patent, a technical article, a document, and the like, which can include component reference numbers in their description and their one or more diagrams or figures. Operation 602 can be implemented in any manner similar to that described herein, but is not limited to such.

At operation 604, the apparatus description viewer system can identify component names and component reference numbers and create a component index or database. Note that operation 604 can be implemented in a wide variety of ways. For example, in an embodiment, the component numbers can be identified at operation 604 by finding each number in the description that is not preceded by the words “figure”, “figures”, “Fig.”, “diagram”, “diagrams” or other words signifying a diagram, but is not limited to such. In an embodiment, the component names can be identified at operation 604 as every noun and adjective preceding the number up to the first word that is not a noun or adjective; e.g., in the sentence, “The invention includes a metal bezel 101,” the component name is “metal bezel” and the component number is “101.” In an embodiment, the component names can be identified at operation 604 by finding every number and then go to the left of the number to find a noun and then maybe any adjectives and then an article which is either “a”, “the”, “said”, and the like, and that is where it stops. Therefore, the component or object name is going to be everything between the number and the article. Operation 604 can be implemented in any manner similar to that described herein, but is not limited to such.

At operation 606 of FIG. 6, the apparatus description viewer system can generate a components index or database based upon any identified component names and component numbers identified at operation 604. It is pointed out that operation 606 can be implemented in a wide variety of ways. For example, operation 606 can be implemented in any manner similar to that described herein, but is not limited to such.

At operation 608, the apparatus description viewer system can identify any components, component names and/or component numbers in the one or more diagrams associated with the description. Note that operation 608 can be implemented in a wide variety of ways. For example, in an embodiment, any component names and/or component numbers in the one or more diagrams can be identified at operation 608 by the apparatus description viewer system using OCR (Optical Character Recognition) technology. In addition, in an embodiment, at operation 608, the apparatus description viewer system can go through the text and determine what diagram each component belongs to. For example, the diagram (or figure) number is typically mentioned before its components. However, if the diagram (or figure) number is mentioned after one or more of its components, the apparatus description viewer system at operation 608 can go to a prior diagram to determine if it includes that component number. If not, the apparatus description viewer system can go to a prior diagram to determine if it includes that component number, and so forth. However, if the first diagram is reached, the apparatus description viewer system at operation 608 can check subsequent diagrams until the one or more diagrams are identified that include that component number. In an embodiment, the component themselves may involve manual assistance to be properly identified them in the one or more diagrams. Operation 608 can be implemented in any manner similar to that described herein, but is not limited to such.

At operation 610 of FIG. 6, the apparatus description viewer system can perform an apparatus description playing process. Note that operation 610 can be implemented in a wide variety of ways. For example, in various embodiments, apparatus description playing process can be method 500 of FIG. 5, but is not limited to such. Operation 610 can be implemented in any manner similar to that described herein, but is not limited to such.

At operation 612, the apparatus description viewer system can display a dropdown (e.g., 202) of any component names and corresponding component numbers, allowing a user to select a component name (e.g., 204), and start playback from a point at which the component name is referenced in the description text. It is pointed out that operation 606 can be implemented in a wide variety of ways. For example, operation 612 can be implemented in any manner similar to that described herein, but is not limited to such. Therefore, method 600 enables automatically generating the functionality of an apparatus description viewer system or device (e.g., 100) in accordance with various embodiments of the invention. In an embodiment, it is noted that method 600 can be modified to operate with multiple descriptions (or documents) that each include component reference numbers in their description and their one or more diagrams.

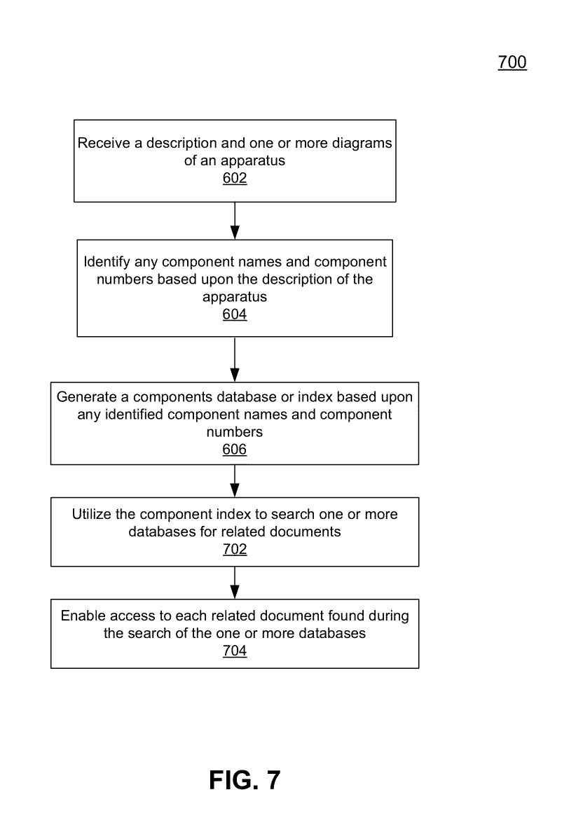

FIG. 7 is a flow diagram of a method 700 for automatically generating search functionality of an apparatus description viewer system or device (e.g., 100) in accordance with various embodiments of the invention. Although specific operations are disclosed in FIG. 7, such operations are examples. The method 700 may not include all of the operations illustrated by FIG. 7. Also, method 700 may include various other operations and/or variations of the operations shown. Likewise, the sequence of the operations of flow diagram 700 can be modified. It is appreciated that not all of the operations in flow diagram 700 may be performed. In various embodiments, one or more of the operations of method 700 can be controlled or managed by software, by firmware, by hardware or by any combination thereof, but is not limited to such. Method 700 can include processes of embodiments of the invention which can be controlled or managed by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium or memory.

In an embodiment, it is noted that the operations 602, 604, and 606 of FIG. 7 can be similar to the operations 602, 604, and 606 of FIG. 6, as described herein. Note that after the completion of operation 606 of FIG. 7, the method 700 proceeds to operation 702 of FIG. 7.

At operation 702 of FIG. 7, the apparatus description viewer system can utilize the component index to search one or more databases for related documents. It is noted that operation 702 can be implemented in a wide variety of ways. For example, in an embodiment, the related documents at operation 702 can include, but is not limited to, patent applications, patents, technical articles, and/or documents that include component reference numbers in their description and their one or more diagrams or figures. In an embodiment, the apparatus description viewer system can utilize the component index at operation 702 to search one or more databases for related documents that include all of the components listed in the component index. In an embodiment, the apparatus description viewer system can utilize the component index at operation 702 to search one or more databases for related documents that include any defined portion or any defined percentage of the components included within the component index. In an embodiment, the defined portion or defined percentage of the components at operation 702 can be defined by a user of the apparatus description viewer system, but is not limited to such. In an embodiment, the defined portion or defined percentage of the components at operation 702 can be predefined. In an embodiment, the apparatus description viewer system can utilize the component index at operation 702 to search one or more databases for related documents by weighting one or more components differently of the component index (e.g., how often a component name appears within the document, how often the component name appears within a searched document, and the like). In an embodiment, the different weighting of one or more components at operation 702 can be defined by a user of the apparatus description viewer system. Operation 702 can be implemented in any manner similar to that described herein, but is not limited to such.

At operation 704, the apparatus description viewer system can enable access to each related document found during the search of the one or more databases. Note that operation 704 can be implemented in a wide variety of ways. For example, in an embodiment, an identifying link of any found related documents (e.g., 402) can be displayed at operation 704 which can enable a user to have access to each related document by selecting each identifying link. More specifically, in an embodiment, if an identifying link is selected, the apparatus description viewer system can perform an apparatus description playback of that related document, such as, performing method 500, but is not limited to such. Operation 704 can be implemented in any manner similar to that described herein, but is not limited to such. Therefore, method 700 enables automatically generating search functionality of an apparatus description viewer system or device (e.g., 100) in accordance with various embodiments of the invention.

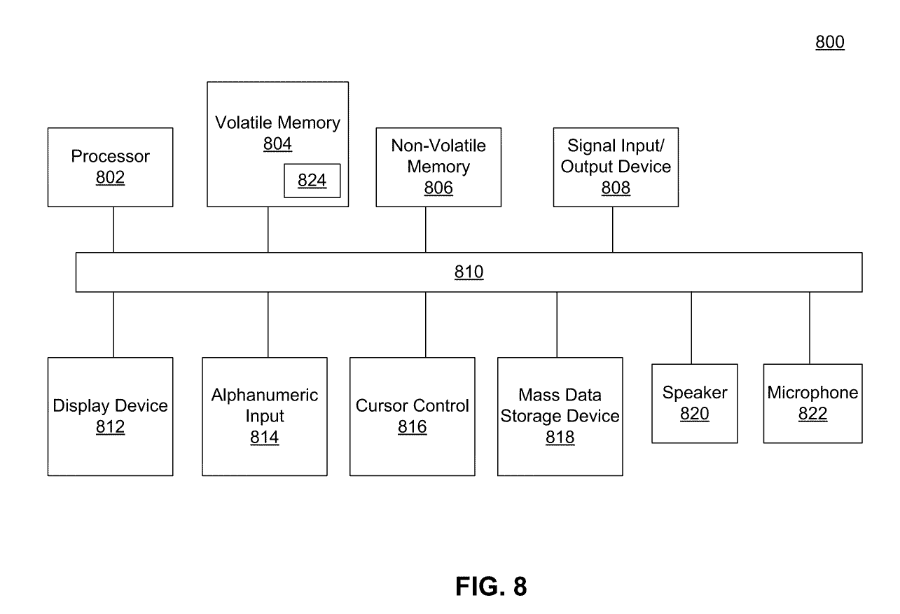

FIG. 8 is a block diagram of an exemplary computing system 800 that may be used in accordance with various embodiments of the disclosure. In various embodiments, the computer system 800 can be an implementation of the apparatus description viewer system 100 of FIG. 1, but is not limited to such. It is understood that system 800 is not strictly limited to be a computing system. Therefore, system 800 is well suited to be any type of computing device (e.g., smart phone, tablet computer, phablet, mobile phone, handheld computing device, laptop computer, portable computing device, server computer, desktop computer, database computer system, computer system, etc.) in accordance with various embodiments of the disclosure. In its various embodiments, system 800 may not include all of the elements illustrated by FIG. 8, or system 800 may include other elements not shown by FIG. 8. Within discussions of various embodiments in accordance with the disclosure herein, certain processes and operations are discussed that can be realized, in some embodiments, as a series of instructions (e.g., software program, software code, and the like) that reside within computer readable memory or storage of computing system 800 and executed by a processor(s) of system 800. When executed, the instructions can cause computer 800 to perform specific operations and exhibit specific behavior which are described herein, but are not limited to such.

Computer system 800 can include an address/data bus 810 for communicating information, one or more central processors 802 coupled with bus 810 for processing information and instructions. Central processor unit(s) 802 may be a microprocessor or any other type of processor. The computer 800 can also include data storage features such as computer usable volatile memory 804, e.g., random access memory (RAM), static RAM, dynamic RAM, etc., coupled with bus 810 for storing information and instructions for central processor(s) 802, computer usable non-volatile memory 806, e.g., read only memory (ROM), programmable ROM, flash memory, erasable programmable read only memory (EPROM), electrically erasable programmable read only memory (EEPROM), etc., coupled with bus 810 for storing static information and instructions for processor(s) 802.

System 800 of FIG. 8 can also include one or more signal generating and receiving devices 808 coupled with bus 810 for enabling system 800 to interface with other electronic devices. The communication interface(s) 808 of the present embodiment may include wired and/or wireless communication technologies. For example in one embodiment, the communication interface 808 is a serial communication port, but could also alternatively be any of a number of well known communication standards and protocols, e.g., a Universal Serial Bus (USB), an Ethernet adapter, a FireWire (IEEE 1394) interface, a parallel port, a small computer system interface (SCSI) bus interface, an infrared (IR) communication port, a Bluetooth wireless communication adapter, a broadband connection, and the like. In an embodiment, a cable or digital subscriber line (DSL) connection may be employed. In such a case the communication interface(s) 808 may include a cable modem or a DSL modem.

The computer system 800 can include an alphanumeric input device 814 including alphanumeric and function keys coupled to the bus 810 for communicating information and command selections to the central processor(s) 802. The computer 800 can also include a cursor control or cursor directing device 816 coupled to the bus 810 for communicating user input information and command selections to the processor(s) 802. The cursor directing device 816 can be implemented using a number of well known devices such as, but not limited to, a touch pad, a touch screen, a mouse, a tracking device, a track ball, a track pad, etc. Alternatively, it is appreciated that a cursor can be directed and/or activated via input from the alphanumeric input device 814 using special keys and key sequence commands. The present embodiment is also well suited to directing a cursor by other means such as, for example, voice commands.

Within FIG. 8, the computer system 800 can also include a computer usable mass data storage device 818 such as a magnetic or optical disk and disk drive (e.g., hard drive or floppy diskette) coupled with bus 810 for storing information and instructions. The computer system 800 can include a display device 812 coupled to bus 810 for displaying video and/or graphics. Note that the display device 812 may be implemented with different technologies. For example, the display device 812 may be implemented with, but is not limited to, a light emitting diode (LED) display, flat panel liquid crystal display (LCD), field emission display (FED), plasma display, cathode ray tube (CRT), or any other display device suitable for displaying video and/or graphic images and alphanumeric characters recognizable to a user.

The computer system 800 can also include an audio speaker(s) 820 coupled with bus 810 for outputting any type of audio signals or sounds produced by computer system 800 that may, for example, be heard and/or recognizable to a user. In addition, the computer system 800 can include an audio microphone(s) 822 coupled with bus 810 for receiving and inputting any type of audio signals or sounds into computer system 800.

Within FIG. 8, note that the volatile memory 804 may store one or more software programs or code 824 in accordance with various embodiments of the disclosure. The one or more software programs or code 824 may include instructions to cause the system 800 to operate or function in any manner similar to that described herein, but not limited to such. It is pointed out that in various embodiments, the one or more software programs or code 824 (or one or more of its components) may be stored by the volatile memory 804, or the non-volatile memory 806, or the mass data storage device 818, or any combination thereof.

Within FIG. 8, it is noted that the components associated with computer system 800 described above may be resident to and associated with one physical computing device. However, one or more of the components associated with computer system 800 may be physically distributed to other locations and be communicatively coupled together (e.g., via one or more networks).

It is noted that the computer system 800 may not include all of the elements illustrated by FIG. 8. Furthermore, the computer system 800 can be implemented to include one or more elements not illustrated by FIG. 8. It is pointed out that the computer system 800 can be utilized or implemented in any manner similar to that described herein, but is not limited to such.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A method comprising:
receiving a first document via a computing device, said first document comprising a description of an apparatus, a diagram comprising a component of said apparatus and a component reference number;
determining a name of said component via said computing device;
displaying said diagram via said computing device;
during said displaying, outputting audible speech of a portion of said description via said computing device; and
utilizing said name to search via said computing device for a second document related to said first document.

2. The method of claim 1, wherein said determining said name comprises using said component reference number and said description.

3. The method of claim 1, wherein said description comprises a plurality of components and a plurality of component numbers.

4. The method of claim 1, further comprising:
displaying said portion of said description via said computing device.

5. The method of claim 1, further comprising:
during said outputting, displaying said portion of said description via said computing device.

6. The method of claim 1, further comprising:
during said outputting, highlighting said component reference number of said diagram via said computing device.

7. The method of claim 1, wherein said utilizing comprises parsing a database.

8. The method of claim 1, wherein said first document is a first patent and said second document is a second patent.

9. The method of claim 1, wherein said utilizing comprises weighting said name to search via said computing device for said second document.

10. A method comprising:
receiving a first document via a computing system, said first document comprising a description of an apparatus and a component of said apparatus, a diagram comprising said component and a component reference number;
determining a name of said component using said description via said computing system;
displaying said diagram via said computing system;
during said displaying said diagram, outputting audible speech of a sentence of said description via said computing system;
during said displaying said diagram, displaying a search interface via said computing system; and
utilizing said name to search via said computing system for a second document related to said first document.

11. The method of claim 10, further comprising:
displaying said sentence of said description via said computing system.

12. The method of claim 10, further comprising:
during said outputting, displaying said sentence of said description via said computing system.

13. The method of claim 10, further comprising:
after said utilizing, displaying via said computing system an identifier for accessing said second document.

14. The method of claim 10, further comprising:
during said outputting, highlighting said component reference number of said diagram via said computing system.

15. The method of claim 10, wherein said utilizing comprises weighting said name to search via said computing device for said second document.

16. A method comprising:
receiving a first document via a handheld computing device, said first document comprising a description of an apparatus and a plurality of components of said apparatus, a diagram comprising said plurality of components and a plurality of component reference numbers;
determining a name of each of said plurality of components via said computing device;
displaying said diagram via said computing device;
during said displaying, outputting audible speech of a portion of said description via said computing device; and
utilizing said plurality of names to search via said computing device for a second document related to said first document.

17. The method of claim 16, wherein said utilizing comprises weighting a name of said plurality of names to search via said computing device for said second document.

18. The method of claim 16, further comprising:
after said utilizing, displaying an identifier via said computing system for accessing said second document.

19. The method of claim 18, further comprising:
after said displaying said identifier, displaying a diagram of said second document via said computing device; and
during said displaying said diagram of said second document, outputting audible speech of a portion of a description of said second document via said computing device.

20. The method of claim 16, wherein said utilizing comprises weighting a name of said plurality of names to search via said computing device for said second document.
